(19) United States
(12) Patent Application Publication
(10) Pub. No.: US 2025/0015345 A1
(43) Pub. Date: Jan. 9, 2025

(54) SOLID ELECTROLYTE MATERIAL AND BATTERY USING THE SAME

(71) Applicant: Panasonic Holdings Corporation, Osaka (JP)

(72) Inventors: Ryoji KANNO, Kanagawa (JP); Kota SUZUKI, Kanagawa (JP); Guowei ZHAO, Hubei (CN); Akihiro SAKAI, Nara (JP)

(21) Appl. No.: 18/892,990

(22) Filed: Sep. 23, 2024

Related U.S. Application Data
(63) Continuation of application No. PCT/JP2022/046689, filed on Dec. 19, 2022.

(30) Foreign Application Priority Data
Mar. 25, 2022 (JP) 2022-049854

(51) Int. Cl. H01M 10/0562

(52) U.S. Cl. CPC H01M 10/0562; H01M 2300/0071

(57) ABSTRACT

A solid electrolyte material according to the present disclosure includes a crystalline phase including Li, Ge, V, Ga, and O, wherein the crystalline phase has a LISICON-type structure. A battery according to the present disclosure includes a positive electrode, a negative electrode, and an electrolyte layer disposed between the positive electrode and the negative electrode. At least one selected from the group consisting of the positive electrode, the negative electrode, and the electrolyte layer includes the solid electrolyte material according to the present disclosure.

This application is a continuation of PCT/JP2022/046689 filed on Dec. 19, 2022, which claims foreign priority of Japanese Patent Application No. 2022-049854 filed on Mar. 25, 2022, the entire contents of both of which are incorporated herein by reference.

### BACKGROUND OF THE INVENTION

### 1. Field of the Invention

The present disclosure relates to a solid electrolyte material and a battery using the same.

### 2. Description of Related Art

Journal of Solid State Chemistry 292 (2020) 121651 discloses a LISICON-type solid electrolyte represented by composition formula Li_{3.55}(Ge_{0.45}Si_{0.10}V_{0.45})O₄.

### SUMMARY OF THE INVENTION

The present disclosure aims to provide a novel and highly useful solid electrolyte material.

A solid electrolyte material of the present disclosure includes a crystalline phase including Li, Ge, V, Ga, and O, wherein
the crystalline phase has a LISICON-type structure.

The present disclosure provides a novel and highly useful solid electrolyte material.

### BRIEF DESCRIPTION OF THE DRAWINGS

FIG. 1 is a cross-sectional view of a battery 1000 according to Embodiment 2.

FIG. 2 is a schematic diagram of a pressure-molding die 300 for use in evaluating the ionic conductivity of solid electrolyte materials.

FIG. 3 shows a graph of a Cole-Cole plot obtained by alternating current (AC) impedance measurement on a solid electrolyte material according to Example 1.

FIG. 4 shows a graph of the X-ray diffraction pattern of the solid electrolyte material according to Example 1.

FIG. 5 shows a graph of the X-ray diffraction pattern of a solid electrolyte material according to Comparative Example 1.

### DETAILED DESCRIPTION

Embodiments of the present disclosure are described below with reference to the drawings.

### Embodiment 1

A solid electrolyte material according to Embodiment 1 includes a crystalline phase including Li, Ge, V, Ga, and O, and the crystalline phase has a LISICON-type structure.

The solid electrolyte material according to Embodiment 1 is a novel and highly useful solid electrolyte material, for example, suitable for lithium-ion conduction. The solid electrolyte material according to Embodiment 1 can have, for example, a practical lithium-ion conductivity, and can have, for example, a high lithium-ion conductivity. Here, a high lithium-ion conductivity is, for example, more than 4.0×10⁻⁵ S/cm near room temperature (e.g., 25° C.). In other words, the solid electrolyte material according to Embodiment 1 can have an ionic conductivity of, for example, more than 4.0×10⁻⁵ S/cm.

The solid electrolyte material according to Embodiment 1 can be used in order to obtain a battery with excellent charge and discharge characteristics. The battery is, for example, an all-solid-state battery. The battery may be a primary battery or a secondary battery.

The solid electrolyte material according to Embodiment 1 is an oxide, which includes oxygen. Oxides are generally stable at high temperatures, and safe when exposed to the atmosphere.

To enhance the ionic conductivity of the solid electrolyte material, the crystalline phase included in the solid electrolyte material according to Embodiment 1 may consist substantially of Li, Ge, V, Ga, and O. “The crystalline phase consisting substantially of Li, Ge, V, Ga, and O” means that the ratio (i.e., mole fraction) of the sum of the amounts of substance of Li, Ge, V, Ga, and O to the total of the amounts of substance of all the elements constituting the crystalline phase is 95% or more. In one example, the ratio may be 98% or more.

To enhance the ionic conductivity of the solid electrolyte material, the crystalline phase included in the solid electrolyte material according to Embodiment 1 may consist of Li, Ge, V, Ga, and O.

The solid electrolyte material according to Embodiment 1 is preferably free of sulfur. The sulfur-free solid electrolyte material does not generate hydrogen sulfide when exposed to the atmosphere, and is accordingly excellent in safety.

The solid electrolyte material according to Embodiment 1 may contain an element unavoidably incorporated. The element is, for example, hydrogen, carbon, or nitrogen. Such an element can be contained in the raw material powder of the solid electrolyte material or present in an atmosphere for manufacturing or storing the solid electrolyte material. In the solid electrolyte material according to Embodiment 1, the element unavoidably incorporated as above is, for example, 1 mol % or less.

To enhance the ionic conductivity of the solid electrolyte material, the molar ratio of Ga to the sum of Ge and V may be more than 0 and 0.5 or less.

To enhance the ionic conductivity of the solid electrolyte material, the crystalline phase included in the solid electrolyte material according to Embodiment 1 may have composition represented by the following formula (1),

$${{Li}_{( 4 - x + a + xa )} ( {Ge}_{( 1 - x )} {V}_{x} )}_{( 1 - a )} {Ga}_{a} {O}_{4} \qquad Formula ( 1 )$$

where 0<a<1.0 and 0<x<1.0 are satisfied.

To enhance the ionic conductivity of the solid electrolyte material, in the formula (1), 0<a<0.5 may be satisfied and 0.02≤a≤0.3 may be satisfied.

To further enhance the ionic conductivity of the solid electrolyte material, in the formula (1), 0.03≤a≤0.3 may be satisfied, 0.03≤a≤0.2 may be satisfied, 0.03≤a≤0.15 may be satisfied, and 0.05≤a≤0.15 may be satisfied.

To enhance the ionic conductivity of the solid electrolyte material, in the formula (1), 0<x≤0.5 may be satisfied and 0.3≤x≤0.5 may be satisfied.

In the formula (1), 0.4≤x≤0.5 may be satisfied and x=0.4 may be satisfied.

To enhance the ionic conductivity of the solid electrolyte material, the crystalline phase included in the solid electrolyte material according to Embodiment 1 may have composition represented by the following formula (2),

$${Li}_{( 3.6 + 0.8 b )} ( {Ge}_{0.6} {V}_{0.4 ( 1 - b )} {Ga}_{0.4 b} ) {O}_{4} \qquad Formula ( 2 )$$

where 0<b<1.0 is satisfied.

To enhance the ionic conductivity of the solid electrolyte material, in the formula (2), 0<b<0.4 may be satisfied.

To enhance the ionic conductivity of the solid electrolyte material, the crystalline phase included in the solid electrolyte material according to Embodiment 1 may have composition represented by the following formula (3),

$${Li}_{( 3.6 + 0.6 c )} ( {Ge}_{0.6 ( 1 - c )} {V}_{0.4} {Ga}_{0.6 c} ) {O}_{4} \qquad Formula ( 3 )$$

where 0<c<1.0 is satisfied.

To enhance the ionic conductivity of the solid electrolyte material, in the formula (3), 0<c<0.25 may be satisfied.

The crystalline phase of the solid electrolyte material is analyzed from the X-ray diffraction pattern obtained by X-ray diffraction measurement. For example, the X-ray diffraction pattern of the solid electrolyte material according to Embodiment 1 can be obtained by X-ray diffraction measurement using the 0-20 method with Cu—Kα radiation (wavelengths of 1.5405 Å and 1.5444 Å, i.e., wavelengths of 0.15405 nm and 0.15444 nm).

In the X-ray diffraction pattern obtained by X-ray diffraction measurement using Cu—Kαradiation, diffraction peaks of the LISICON-type structure appear at diffraction angles 2 θ of 16.2°, 19.1°, 21.6°, 22.3°, 23.8°, 27.8°, and 28.5°, for example. In other words, the crystalline phase with these peaks has a LISICON-type structure. The positions of the peaks may allow for a margin of error of +1°.

In solid electrolyte materials including a crystalline phase having a LISICON-type structure, pathways for lithium ion diffusion are easily formed in the crystals. Consequently, the solid electrolyte material according to Embodiment 1 has a high ionic conductivity.

The solid electrolyte material according to Embodiment 1 may include a phase having a structure other than the LISICON-type structure. In this case, the phase having the structure other than the LISICON-type structure can be confirmed from a diffraction peak other than that of the LISICON-type structure. From the viewpoint of ionic conductivity, the amount of the phase having the structure other than the LISICON-type structure in the solid electrolyte material according to Embodiment 1 is preferably as small as possible.

The solid electrolyte material according to Embodiment 1 sometimes contains, as an unavoidable impurity, a crystalline form (e.g., amorphous phase) that cannot be confirmed from the X-ray diffraction pattern.

The solid electrolyte material according to Embodiment 1 has a shape that is not limited. The shape is, for example, acicular, spherical, or ellipsoidal. The solid electrolyte material according to Embodiment 1 may be particulate. The solid electrolyte material according to Embodiment 1 may be formed into a pellet or plate shape.

In the case where the solid electrolyte material according to Embodiment 1 is, for example, particulate (e.g., spherical), the solid electrolyte material may have a median diameter of 0.1 μm or more and 100 μm or less. The median diameter means the particle diameter at a cumulative volume equal to 50% in the volumetric particle size distribution. The volumetric particle size distribution is measured with, for example, a laser diffractometer or an image analyzer.

The solid electrolyte material according to Embodiment 1 may have a median diameter of 0.5 μm or more and 10 μm or less. In this case, the solid electrolyte material according to Embodiment 1 has a higher ionic conductivity. Furthermore, in the case where the solid electrolyte material according to Embodiment 1 is mixed with another material such as an active material, the solid electrolyte material according to Embodiment 1 and the other material are favorably dispersed.

### Method for Manufacturing Solid Electrolyte Material

The solid electrolyte material according to Embodiment 1 is manufactured by, for example, the following method.

Raw material powders of multiple oxides are mixed so as to obtain a desired composition.

In one example where the desired composition is Li_{3.68}Ge_{0.6}Ga_{0.04}V_{0.36}O₄, Li₂O raw material powder, GeO₂ raw material powder, Ga₂O₃ raw material powder, and V₂O₅raw material powder (i.e., raw material powders of four oxides) are mixed in an approximate molar ratio of Li₂O:GeO₂:Ga₂O₃:V₂O₅=1.84:0.6:0.02:0.18.

The raw material powders may be mixed in a molar ratio adjusted in advance so as to cancel out a composition change that can occur in the synthesis process.

The mixed raw material powders are fired in the atmosphere to react with each other to obtain a reaction product. The firing process may be performed in an inert gas atmosphere or in a vacuum.

In the firing process, the mixed material powder may be placed in a container (e.g., crucible or sealed tube) for firing in a heating furnace.

Alternatively, the raw material powders may be mechanochemically reacted with each other in a mixer such as a planetary ball mill to obtain a reaction product. In other words, the raw materials may be mixed and reacted by mechanochemical milling. The reaction product obtained mechanochemically may be additionally fired in the atmosphere. To form into a disk-or plate-shaped pellet, synthesis and subsequent molding with a pressure-molding die or the like may be followed by firing. In the final firing, a compact pre-molded into a desired shape with a die or punch may be fired to achieve a high density.

Through these processes, the solid electrolyte material according to Embodiment 1 is obtained.

The composition ratio in the solid electrolyte material can be determined by, for example, high-frequency inductively coupled plasma (ICP) emission spectrometry.

### Embodiment 2

Embodiment 2 of the present disclosure is described below. The matters described in Embodiment 1 can be omitted.

In Embodiment 2, a battery using the solid electrolyte material according to Embodiment 1 is described.

A battery according to Embodiment 2 includes a positive electrode, a negative electrode, and an electrolyte layer. The electrolyte layer is provided between the positive electrode and the negative electrode. At least one selected from the group consisting of the positive electrode, the electrolyte layer, and the negative electrode includes the solid electrolyte material according to Embodiment 1.

The battery according to Embodiment 2 includes the solid electrolyte material according to Embodiment 1, and consequently has excellent charge and discharge characteristics. The battery may be an all-solid-state battery.

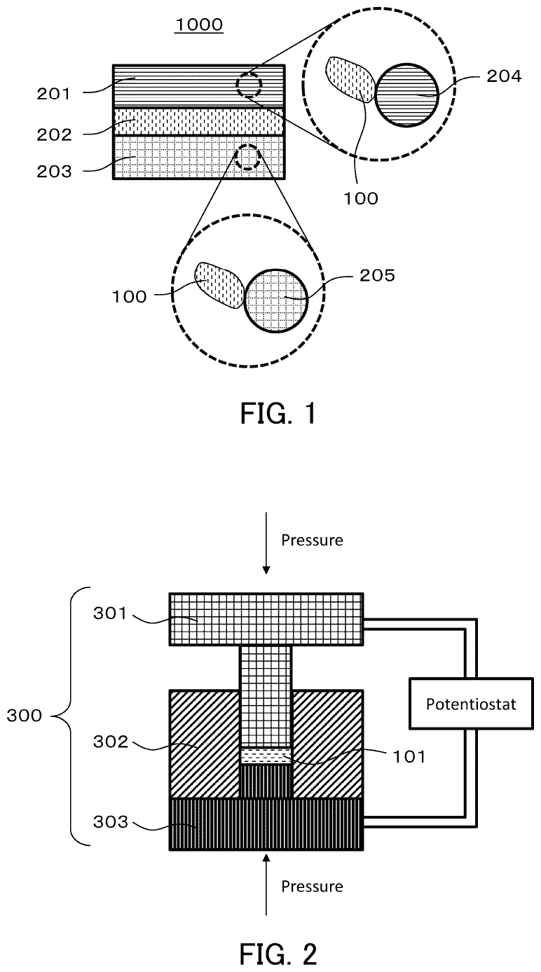

FIG. 1 is a cross-sectional view of a battery 1000 according to Embodiment 2.

The battery 1000 according to Embodiment 2 includes a positive electrode 201, an electrolyte layer 202, and a negative electrode 203. The electrolyte layer 202 is provided between the positive electrode 201 and the negative electrode 203.

The positive electrode 201 includes positive electrode active material particles 204 and solid electrolyte particles 100.

The electrolyte layer 202 includes an electrolyte material. The electrolyte material is, for example, a solid electrolyte material.

The negative electrode 203 includes negative electrode active material particles 205 and the solid electrolyte particles 100.

The solid electrolyte particles 100 are particles including the solid electrolyte material according to Embodiment 1. The solid electrolyte particles 100 may be particles formed of the solid electrolyte material according to Embodiment 1, or particles including the solid electrolyte material according to Embodiment 1 as the main component. Here, the particles including the solid electrolyte material according to Embodiment 1 as the main component mean particles in which the component contained in the highest molar ratio is the solid electrolyte material according to Embodiment 1.

The solid electrolyte particles 100 may have a median diameter of 0.1 μm or more and 100 μm or less, and may have a median diameter of 0.5 μm or more and 10 μm or less. In this case, the solid electrolyte particles 100 have a higher ionic conductivity.

The positive electrode 201 includes a material capable of occluding and releasing metal ions (e.g., lithium ions). The material is, for example, a positive electrode active material (e.g., the positive electrode active material particles 204).

Examples of the positive electrode active material include a lithium-containing transition metal oxide, a transition metal fluoride, a polyanion material, a fluorinated polyanion material, a transition metal sulfide, a transition metal oxyfluoride, a transition metal oxysulfide, and a transition metal oxynitride. Examples of the lithium-containing transition metal oxide include Li(Ni, Co, Al)O₂ and LiCoO₂.

In the present disclosure, the notation “(A, B,C)” in a chemical formula means “at least one selected from the group consisting of A, B, and C”. For example, “(Ni, Co,Al)” is synonymous with “at least one selected from the group consisting of Ni, Co, and Al”.

The positive electrode active material particles 204 may have a median diameter of 0.1 μm or more and 100 μm or less. In the case where the positive electrode active material particles 204 have a median diameter of 0.1 μm or more, the positive electrode active material particles 204 and the solid electrolyte particles 100 can be favorably dispersed in the positive electrode 201. This enhances the charge and discharge characteristics of the battery. In the case where the positive electrode active material particles 204 have a median diameter of 100 μm or less, lithium diffuses in the positive electrode active material particles 204 at an enhanced rate. This enables the battery to operate at a high output.

The positive electrode active material particles 204 may have a larger median diameter than the solid electrolyte particles 100. In this case, the positive electrode active material particles 204 and the solid electrolyte particles 100 can be favorably dispersed in the positive electrode 201.

To enhance the energy density and output of the battery, the ratio of the volume of the positive electrode active material particles 204 to the sum of the volume of the positive electrode active material particles 204 and the volume of the solid electrolyte particles 100 in the positive electrode 201 may be 0.30 or more and 0.95 or less.

To enhance the energy density and output of the battery, the positive electrode 201 may have a thickness of 10 μm or more and 500 μm or less.

The electrolyte layer 202 includes an electrolyte material. The electrolyte material is, for example, the solid electrolyte material according to Embodiment 1. The electrolyte layer 202 may be a solid electrolyte layer.

The electrolyte layer 202 may consist of the solid electrolyte material according to Embodiment 1. Alternatively, the electrolyte layer 202 may consist of a solid electrolyte material different from the solid electrolyte material according to Embodiment 1.

Examples of the solid electrolyte material different from the solid electrolyte material according to Embodiment 1 include Li₂MgX′₄, Li₂FeX′₄, Li(Al, Ga, In)X′₄, Li₃(Al, Ga, In)X′₆, and LiI, where X′ is at least one selected from the group consisting of F, CI, Br, and I. Thus, the solid electrolyte material different from the solid electrolyte material according to Embodiment 1 may be a solid electrolyte containing a halogen element, i.e., a halide solid electrolyte.

The solid electrolyte material according to Embodiment 1 is hereinafter referred to as a first solid electrolyte material. A solid electrolyte material different from the solid electrolyte material according to Embodiment 1 is hereinafter referred to as a second solid electrolyte material.

The electrolyte layer 202 may include the first solid electrolyte material, and in addition, include the second solid electrolyte material. In the electrolyte layer 202, the first solid electrolyte material and the second solid electrolyte material may be uniformly dispersed. A layer formed of the first solid electrolyte material and a layer formed of the second solid electrolyte material may be stacked along the stacking direction for the battery 1000.

The electrolyte layer 202 may have a thickness of 1 μm or more and 1000 μm or less. In the case where the electrolyte layer 202 has a thickness of 1 μm or more, the positive electrode 201 and the negative electrode 203 are less prone to be short-circuited. In the case where the electrolyte layer 202 has a thickness of 1000 μm or less, the battery can operate at a high output.

The negative electrode 203 includes a material capable of occluding and releasing metal ions such as lithium ions. The material is, for example, a negative electrode active material (e.g., the negative electrode active material particles 205).

Examples of the negative electrode active material include a metal material, a carbon material, an oxide, a nitride, a tin compound, and a silicon compound. The metal material may be a simple substance of metal or may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material include silicon (i.e., Si), tin (i.e., Sn), a silicon compound, and a tin compound.

The negative electrode active material particles 205 may have a median diameter of 0.1 μm or more and 100 μm or less. In the case where the negative electrode active material particles 205 have a median diameter of 0.1 μm or more, the negative electrode active material particles 205 and the solid electrolyte particles 100 can be favorably dispersed in the negative electrode 203. This enhances the charge and discharge characteristics of the battery. In the case where the negative electrode active material particles 205 have a median diameter of 100 μm or less, lithium diffuses in the negative electrode active material particles 205 at an enhanced rate. This enables the battery to operate at a high output.

The negative electrode active material particles 205 may have a larger median diameter than the solid electrolyte particles 100. In this case, the negative electrode active material particles 205 and solid electrolyte particles 100 can be favorably dispersed in the negative electrode 203.

To enhance the energy density and output of the battery, the ratio of the volume of the negative electrode active material particles 205 to the sum of the volume of the negative electrode active material particles 205 and the volume of the solid electrolyte particles 100 in the negative electrode 203 may be 0.30 or more and 0.95 or less.

To enhance the energy density and output of the battery, the negative electrode 203 may have a thickness of 10 μm or more and 500 μm or less.

At least one selected from the group consisting of the positive electrode 201, the electrolyte layer 202, and the negative electrode 203 may include the second solid electrolyte material for the purpose of enhancing the ionic conductivity, chemical stability, and electrochemical stability.

As described above, the second solid electrolyte material may be a halide solid electrolyte.

Examples of the halide solid electrolyte include Li₂MgX′₄, Li₂FeX′₄, Li(Al, Ga, In)X′₄, Li₃(Al, Ga, In)X′₆, and LiI, where X′ is at least one selected from the group consisting of F, Cl, Br, and I.

Another example of the halide solid electrolyte is a compound represented by LiₚMe_{q}YᵣZ₆, where p+m′q+3r=6 and r>0 are satisfied, Me is at least one element selected from the group consisting of metalloid elements and metal elements other than Li or Y, the value of m′ represents the valence of Me, and Z is at least one selected from the group consisting of F, Cl, Br, and I. The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se). To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The second solid electrolyte material may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

The second solid electrolyte material may be an oxide solid electrolyte.

Examples of the oxide solid electrolyte include:
(i) a NASICON-type solid electrolyte, such as LiTi₂(PO₄)₃ or its element-substituted substance;
(ii) a perovskite-type solid electrolyte, such as (LaLi)TiO₃;
(iii) a LISICON-type solid electrolyte, such as Li₁₄ZnGe₄O₁₆, Li₄SiO₄, LiGeO₄, or its element-substituted substance;
(iv) a garnet-type solid electrolyte, such as Li₇La₃Zr₂O₁₂ or its element-substituted substance; and
(v) Li₃PO₄ and its N-substituted substance.

The second solid electrolyte material may be an organic polymer solid electrolyte.

An example of the organic polymer solid electrolyte is a compound of a polymer compound and a lithium salt.

The polymer compound may have an ethylene oxide structure. The polymer compound having an ethylene oxide structure can contain a lithium salt in a large amount, and accordingly can have a further enhanced ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used.

At least one selected from the group consisting of the positive electrode 201, the electrolyte layer 202, and the negative electrode 203 may include a nonaqueous electrolyte solution, a gel electrolyte, or an ionic liquid for the purpose of facilitating transfer of lithium ions to enhance the output characteristics of the battery.

The nonaqueous electrolyte solution contains a nonaqueous solvent and a lithium salt dissolved in the nonaqueous solvent.

Examples of the nonaqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethylmethyl carbonate, and fluorodimethylene carbonate. One nonaqueous solvent selected from the above may be used alone. Alternatively, a mixture of two or more nonaqueous solvents selected from the above may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used. The lithium salt has a concentration of, for example, 0.5 mol/L or more and 2 mol/L or less.

The gel electrolyte can be a polymer material impregnated with a nonaqueous electrolyte solution. Examples of the polymer material include polyethylene oxide, polyacrylonitrile, polyvinylidene fluoride, polymethylmethacrylate, and a polymer having an ethylene oxide bond.

Examples of the cation contained in the ionic liquid include:
(i) an aliphatic chain quaternary salt, such as tetraalkylammonium or tetraalkylphosphonium;
(ii) an aliphatic cyclic ammonium, such as pyrrolidinium, morpholinium, imidazolinium, tetrahydropyrimidinium, piperazinium, or piperidinium; and
(iii) a nitrogen-containing heterocyclic aromatic cation, such as pyridinium or imidazolium.

Examples of the anion contained in the ionic liquid include PF₆⁻, BF₄⁻, SbF₆⁻, AsF₆⁻, SO₃CF₃⁻, N (SO₂CF₃)₂⁻, N (SO₂C₂F₅)₂⁻, N (SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may include a binder for the purpose of enhancing the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. The binder can also be a copolymer. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above materials may be used as the binder.

At least one selected from the positive electrode 201 and the negative electrode 203 may include a conductive additive in order to enhance the electronic conductivity.

Examples of the conductive additive include:
(i) graphite, such as natural graphite or artificial graphite;
(ii) carbon black, such as acetylene black or Ketjenblack;
(iii) a conductive fiber, such as a carbon fiber or a metal fiber;
(iv) fluorinated carbon;
(v) a metal powder, such as an aluminum powder;
(vi) a conductive whisker, such as a zinc oxide whisker or a potassium titanate whisker;
(vii) a conductive metal oxide, such as titanium oxide; and
(viii) a conductive polymer compound, such as polyaniline compound, polypyrrole compound, or polythiophene compound. To reduce the cost, the conductive additive in the above (i) or (ii) may be used.

Examples of the shape of the battery according to Embodiment 2 include a coin type, a cylindrical type, a prismatic type, a sheet type, a button type, a flat type, and a stacked type.

The battery according to Embodiment 2 may be manufactured by, for example, preparing a material for forming a positive electrode, a material for forming an electrolyte layer, and a material for forming a negative electrode, and producing by a known method a stack composed of the positive electrode, the electrolyte layer, and the negative electrode disposed in this order.

### OTHER EMBODIMENTS

### (Supplementary Description)

The description of the embodiments above discloses the following techniques.

### (Technique 1)

A solid electrolyte material including a crystalline phase including Li, Ge, V, Ga, and O, wherein
the crystalline phase has a LISICON-type structure.

This configuration can achieve a novel and highly useful solid electrolyte material.

Furthermore, with the configuration, the solid electrolyte material can have a practical lithium-ion conductivity, for example.

### (Technique 2)

The solid electrolyte material according to Technique 1, wherein the crystalline phase consists of Li, Ge, V, Ga, and O. This configuration can enhance the ionic conductivity of the solid electrolyte material.

### (Technique 3)

The solid electrolyte material according to Technique 1 or 2, wherein a molar ratio of Ga to a sum of Ge and V is more than 0 and 0.5 or less. This configuration can enhance the ionic conductivity of the solid electrolyte material.

### (Technique 4)

The solid electrolyte material according to Technique 1 or 2, wherein the crystalline phase has composition represented by the following formula (1),

$${{Li}_{( 4 - x + a + xa )} ( {Ge}_{( 1 - x )} {V}_{x} )}_{( 1 - a )} {Ga}_{a} {O}_{4} \qquad Formula ( 1 )$$

where 0<a<1.0 and 0<x<1.0 are satisfied.

This configuration can enhance the ionic conductivity of the solid electrolyte material.

### (Technique 5)

The solid electrolyte material according to Technique 4, wherein in the formula (1), 0<a<0.5 is satisfied. This configuration can enhance the ionic conductivity of the solid electrolyte material.

### (Technique 6)

The solid electrolyte material according to Technique 5, wherein in the formula (1), 0.02≤a≤0.3 is satisfied. This configuration can enhance the ionic conductivity of the solid electrolyte material.

### (Technique 7)

The solid electrolyte material according to Technique 6, wherein in the formula (1), 0.05≤a≤0.15 is satisfied. This configuration can further enhance the ionic conductivity of the solid electrolyte material.

### (Technique 8)

The solid electrolyte material according to any one of Techniques 4 to 7, wherein in the formula (1), 0<x≤0.5 is satisfied. This configuration can enhance the ionic conductivity of the solid electrolyte material.

### (Technique 9)

The solid electrolyte material according to Technique 8, wherein in the formula (1), 0.3≤x≤0.5 is satisfied. This configuration can enhance the ionic conductivity of the solid electrolyte material.

### (Technique 10)

The solid electrolyte material according to Technique 1 or 2, wherein the crystalline phase has composition represented by the following formula (2) or formula (3),

$${Li}_{( 3.6 + 0.8 b )} ( {Ge}_{0.6} {V}_{0.4 ( 1 - b )} {Ga}_{0.4 b} ) {O}_{4} \qquad Formula ( 2 )$$

where 0<b<1.0 is satisfied, and

$${Li}_{( 3.6 + 0.6 c )} ( {Ge}_{0.6 ( 1 - c )} {V}_{0.4} {Ga}_{0.6 c} ) {O}_{4} \qquad Formula ( 3 )$$

where 0<c<1.0 is satisfied.

This configuration can enhance the ionic conductivity of the solid electrolyte material.

### (Technique 11)

The solid electrolyte material according to Technique 10, wherein the crystalline phase has composition represented by the formula (2), and in the formula (2), 0<b<0.4 is satisfied. This configuration can enhance the ionic conductivity of the solid electrolyte material.

### (Technique 12)

The solid electrolyte material according to Technique 10, wherein the crystalline phase has composition represented by the formula (3), and in the formula (3), 0<c<0.25 is satisfied. This configuration can enhance the ionic conductivity of the solid electrolyte material.

### (Technique 13)

A battery including:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to any one of Techniques 1 to 12.

This configuration can achieve a battery having excellent charge and discharge characteristics.

### EXAMPLES

The present disclosure is described in more detail below with reference to examples and a comparative example.

A solid electrolyte material according to the example can be represented by the above formula (1).

### Example 1

### (Production of Solid Electrolyte Material)

In an argon atmosphere with a dew point −60° C. or less (hereinafter referred to as a “dry argon atmosphere”), Li₂O, GeO₂, Ga₂O₃, and V₂O₅ were prepared as the raw material powders in the molar ratio of Li₂O:GeO₂:Ga₂O₃:V₂O₅=1.84:0.6:0.02:0.18. These raw material powders were pulverized and mixed in an alumina mortar. The resulting mixed powder was fed into a pulverizing and mixing zirconia vessel together with zirconia balls. The mixed powder was then pulverized and mixed at 1000 rpm for 4 hours. The resulting powder (500 mg) after the pulverization was compacted at 180MPa to be shaped into a pellet.

The pellet was allowed to stand in an alumina crucible and the crucible was introduced into an electric furnace. The pellet was then fired at 900° C. for 12 hours in the atmosphere. The resulting fired product was pulverized in an alumina mortar.

Through the above processes, a powdered solid electrolyte material according to Example 1 was obtained. The solid electrolyte material according to Example 1 had composition represented by Li_{3.68}Ge_{0.6}V_{0.36}Ga_{0.04}O₄. The composition of the solid electrolyte material obtained is expressed here as the composition determined from its charge ratio, because a preliminary experiment demonstrated that the measurement result of the composition of the solid electrolyte material is almost equal to the composition determined from the charge ratio.

### (Evaluation of Ionic Conductivity)

FIG. 2 is a schematic diagram of a pressure-molding die 300 used to evaluate the ionic conductivity of solid electrolyte materials.

The pressure-molding die 300 included an upper punch 301, an insulating tube 302, and a lower punch 303. The upper punch 301 and the lower punch 303 were both made of stainless steel, which is electronically conductive.

With the pressure-molding die 300 shown in FIG. 2, the solid electrolyte material according to Example 1 was measured for ionic conductivity by the following method.

A pressure of 230 MPa was applied to the solid electrolyte material (65 mg) according to Example 1 to obtain a pellet. The pellet was allowed to stand in an alumina crucible and the crucible was introduced into an electric furnace. The pellet was then fired at 900° C. for 12 hours in the atmosphere.

A gold paste was applied to both sides of the pellet, followed by drying at 300° C. After the drying, the pellet 101 was filled into the pressure-molding die 300.

The upper punch 301 and the lower punch 303 were connected to a potentiostat equipped with a frequency response analyzer. The solid electrolyte material was measured for impedance in a thermostatic chamber by electrochemical impedance measurement.

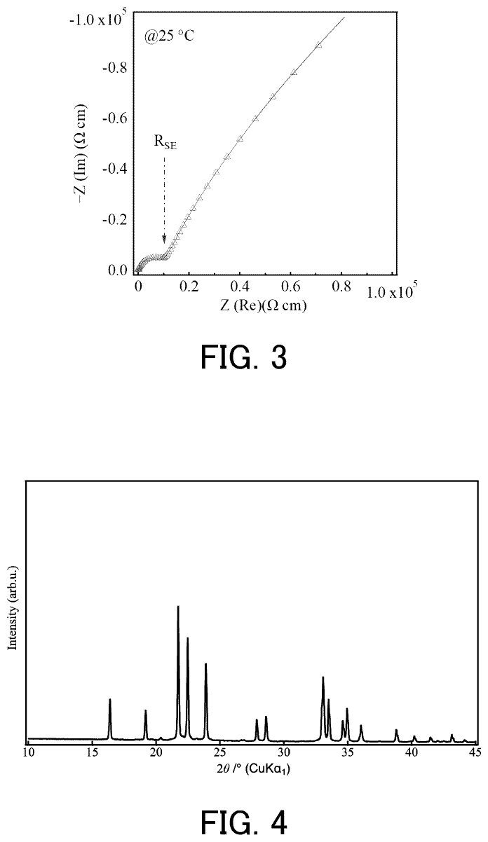

FIG. 3 shows a graph of a Cole-Cole plot obtained by alternating current (AC) impedance measurement on the solid electrolyte material according to Example 1.

In FIG. 3, the real value of the complex impedance at the measurement point where the absolute value of the phase of the complex impedance was smallest was defined as the resistance value of the solid electrolyte material to ionic conduction. For the real value, see an arrow R_{SE} shown in FIG. 3. The ionic conductivity was calculated from the resistance value by the following mathematical formula (4):

$$σ = {( {R}_{SE} \times S / t )}^{- 1} \qquad ( 4 )$$

where σ represents the ionic conductivity; S represents the contact area of the solid electrolyte material with the upper punch 301, that is, S is equal to the cross-sectional area of the measurement sample in FIG. 2; R_{SE} represents the resistance value of the solid electrolyte material in the impedance measurement; and t represents the thickness of the measurement sample, that is, t is equal to the thickness of the pellet of the solid electrolyte material in FIG. 2.

The solid electrolyte material according to Example 1 had an ionic conductivity of 7.2×10⁻⁵ S/cm measured at 25° C.

### (X-Ray Diffraction Measurement)

FIG. 4 shows a graph of the X-ray diffraction pattern of the solid electrolyte material according to Example 1. The result shown in FIG. 4 was obtained from measurement conducted by the following method.

The powdered solid electrolyte material according to Example 1 was pulverized in an alumina mortar and then filled into an X-ray diffraction measurement cell. X-ray diffraction measurement was conducted with an X-ray diffractometer (SmartLab manufactured by Rigaku Corporation) at room temperature under the atmosphere with the measurement accuracy range from 10° to 60° and the step width of 0.01°. The X-ray wavelength selected was monochromatized CuKα1. In other words, the X-ray diffraction pattern was measured by the 0-20 method using Cu—Kα radiation (wavelength 1.5405 Å, i.e., 0.15405 nm).

In the X-ray diffraction pattern of the solid electrolyte material according to Example 1, characteristic diffraction peaks were present at diffraction angles 2 θ of 16.2°, 19.1°, 21.6°, 22.3°, 23.8°, 27.8°, and 28.5°. Therefore, the solid electrolyte material according to Example 1 included a crystalline phase having a LISICON-type structure.

### Examples 2 to 12

### (Production of Solid Electrolyte Material)

In Example 2, Li₂O, GeO₂, Ga₂O₃, and V₂O₅ were prepared as the raw material powders in the molar ratio of Li₂O:GeO₂:Ga₂O₃:V₂O₅=1.86:0.6:0.03:0.17.

In Example 3, Li₂O, GeO₂, Ga₂O₃, and V₂O₅ were prepared as the raw material powders in the molar ratio of Li₂O:GeO₂:Ga₂O₃:V₂O₅=1.92:0.6:0.06:0.14.

In Example 4, Li₂O, GeO₂, Ga₂O₃, and V₂O₅ were prepared as the raw material powders in the molar ratio of Li₂O:GeO₂:Ga₂O₃:V₂O₅=1.835:0.57:0.025:0.19.

In Example 5, Li₂O, GeO₂, Ga₂O₃, and V₂O₅ were prepared as the raw material powders in the molar ratio of Li₂O:GeO₂:Ga₂O₃:V₂O₅=1.87:0.54:0.05:0.18.

In Example 6, Li₂O, GeO₂, Ga₂O₃, and V₂O₅ were prepared as the raw material powders in the molar ratio of Li₂O:GeO₂:Ga₂O₃:V₂O₅=1.905:0.51:0.075:0.17.

In Example 7, Li₂O, GeO₂, Ga₂O₃, and V₂O₅ were prepared as the raw material powders in the molar ratio of Li₂O:GeO₂:Ga₂O₃:V₂O₅=1.94:0.48:0.1:0.16.

In Example 8, Li₂O, GeO₂, Ga₂O₃, and V₂O₅ were prepared as the raw material powders in the molar ratio of Li₂O:GeO₂:Ga₂O₃:V₂O₅=1.815:0.57:0.015:0.2.

In Example 9, Li₂O, GeO₂, Ga₂O₃, and V₂O₅ were prepared as the raw material powders in the molar ratio of Li₂O:GeO₂:Ga₂O₃:V₂O₅=1.83:0.54:0.03:0.2.

In Example 10, Li₂O, GeO₂, Ga₂O₃, and V₂O₅ were prepared as the raw material powders in the molar ratio of Li₂O:GeO₂:Ga₂O₃:V₂O₅=1.845:0.51:0.045:0.2.

In Example 11, Li₂O, GeO₂, Ga₂O₃, and V₂O₅ were prepared as the raw material powders in the molar ratio of Li₂O:GeO₂:Ga₂O₃:V₂O₅=1.86:0.48:0.06:0.2.

In Example 12, Li₂O, GeO₂, Ga₂O₃, and V₂O₅ were prepared as the raw material powders in the molar ratio of Li₂O:GeO₂:Ga₂O₃:V₂O₅=1.89:0.42:0.09:0.2.

Except for the above points, the same procedures were conducted as in Example 1 to obtain solid electrolyte materials according to Examples 2 to 12.

The solid electrolyte materials according to Examples 2 to 12 were confirmed to include a crystalline phase having a LISICON-type structure as in Example 1.

### (Evaluation of Ionic Conductivity)

The solid electrolyte materials according to Examples 2 to 12 were measured for ionic conductivity in the same manner as in Example 1. The measurement results are shown in Table 1.

### Comparative Example 1

In Comparative Example 1, Li₂O, GeO₂, and V₂O₅ were prepared as the raw material powders in the molar ratio of Li₂O:GeO₂:V₂O₅=1.8:0.6:0.2. Except for the above point, the same procedure was conducted as in Example 1 to obtain a solid electrolyte material according to Comparative Example 1.

The solid electrolyte material according to Comparative Example 1 was measured for ionic conductivity in the same manner as in Example 1. The measurement result is shown in Table 1.

The solid electrolyte material according to Comparative Example 1 was measured for X-ray diffraction in the same manner as in Example 1.

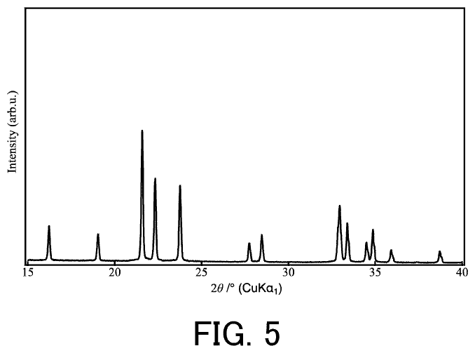

FIG. 5 shows a graph of the X-ray diffraction pattern of the solid electrolyte material according to Comparative Example 1.

Table 1 shows the composition of the solid electrolyte materials according to the examples and the comparative example.

TABLE 1

| | | | | Ionic |
|---|---|---|---|---|
| | | | | conductivity |
| | Composition | a | x | (×10⁻⁵ S/cm) |
| Example 1 | Li_{3.68}Ge_{0.6}V_{0.36}Ga_{0.04}O₄ | 0.04 | 0.3750 | 7.2 |
| Example 2 | Li_{3.72}Ge_{0.6}V_{0.34}Ga_{0.06}O₄ | 0.06 | 0.3617 | 12.5 |
| Example 3 | Li_{3.84}Ge_{0.6}V_{0.28}Ga_{0.12}O₄ | 0.12 | 0.3182 | 6.9 |
| Example 4 | Li_{3.67}Ge_{0.57}V_{0.38}Ga_{0.05}O₄ | 0.05 | 0.4 | 9.95 |
| Example 5 | Li_{3.74}Ge_{0.54}V_{0.36}Ga_{0.1}O₄ | 0.1 | 0.4 | 10.5 |
| Example 6 | Li_{3.81}Ge_{0.51}V_{0.34}Ga_{0.15}O₄ | 0.15 | 0.4 | 8.1 |
| Example 7 | Li_{3.88}Ge_{0.48} V_{0.32}Ga_{0.2}O₄ | 0.2 | 0.4 | 4.1 |
| Example 8 | Li_{3.63}Ge_{0.57}V_{0.4}Ga_{0.03}O₄ | 0.03 | 0.4124 | 8.2 |
| Example 9 | Li_{3.66}Ge_{0.54}V_{0.4}Ga_{0.06}O₄ | 0.06 | 0.4255 | 11.2 |
| Example 10 | Li_{3.69}Ge_{0.51}V_{0.4}Ga_{0.09}O₄ | 0.09 | 0.4396 | 9.7 |
| Example 11 | Li_{3.72}Ge_{0.48} V_{0.4}Ga_{0.12}O₄ | 0.12 | 0.4545 | 7.6 |
| Example 12 | Li_{3.78}Ge_{0.42}V_{0.4}Ga_{0.18}O₄ | 0.18 | 0.4878 | 6.7 |
| Comparative | Li_{3.6}Ge_{0.6}V_{0.4}O₄ | 0 | 0.4 | 4.0 |
| Example 1 | | | | |

### Discussion

The solid electrolyte materials according to Examples 1 to 12 each have a lithium-ion conductivity of more than 4.0×10⁻⁵ S/cm near room temperature. This is presumably because, as is evident from the comparison of Examples 1 to 12 with Comparative Example 1, the inclusion of Ga facilitates the formation of pathways for lithium ion diffusion in the crystal lattice.

### INDUSTRIAL APPLICABILITY

The solid electrolyte material and the manufacturing method therefor of the present disclosure are used, for example, in batteries (e.g., all-solid-state lithium-ion secondary batteries).

What is claimed is:

1. A solid electrolyte material comprising a crystalline phase including Li, Ge, V, Ga, and O, wherein the crystalline phase has a LISICON-type structure.

2. The solid electrolyte material according to claim 1, wherein the crystalline phase consists of Li, Ge, V, Ga, and O.

3. The solid electrolyte material according to claim 1, wherein a molar ratio of Ga to a sum of Ge and V is more than 0 and 0.5 or less.

4. The solid electrolyte material according to claim 1, wherein the crystalline phase has composition represented by the following formula (1),
$${{Li}_{( 4 - x + a + xa )} ( {Ge}_{( 1 - x )} {V}_{x} )}_{( 1 - a )} {Ga}_{a} {O}_{4} \qquad Formula ( 1 )$$
where 0<a<1.0 and 0<x<1.0 are satisfied.

5. The solid electrolyte material according to claim 4, wherein in the formula (1), 0<a<0.5 is satisfied.

6. The solid electrolyte material according to claim 5, wherein in the formula (1), 0.02≤a≤0.3 is satisfied.

7. The solid electrolyte material according to claim 6, wherein in the formula (1), 0.05≤a≤0.15 is satisfied.

8. The solid electrolyte material according to claim 4, wherein in the formula (1), 0<x<0.5 is satisfied.

9. The solid electrolyte material according to claim 8, wherein in the formula (1), 0.3≤x≤0.5 is satisfied.

10. The solid electrolyte material according to claim 1, wherein the crystalline phase has composition represented by the following formula (2) or formula (3),
$${Li}_{( 3.6 + 0.8 b )} ( {Ge}_{0.6} {V}_{0.4 ( 1 - b )} {Ga}_{0.4 b} ) {O}_{4} \qquad Formula ( 2 )$$
where 0<b<1.0 is satisfied, and
$${Li}_{( 3.6 + 0.6 c )} ( {Ge}_{0.6 ( 1 - c )} {V}_{0.4} {Ga}_{0.6 c} ) {O}_{4} \qquad Formula ( 3 )$$
where 0<c<1.0 is satisfied.

11. The solid electrolyte material according to claim 10, wherein the crystalline phase has composition represented by the formula (2), and in the formula (2), 0<b<0.4 is satisfied.

12. The solid electrolyte material according to claim 10, wherein
the crystalline phase has composition represented by the formula (3), and in the formula (3), 0<c<0.25 is satisfied.

13. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to claim 1.
